(19) United States
(12) Patent Application Publication
(10) Pub. No.: US 2002/0091780 A1
(43) Pub. Date: Jul. 11, 2002

(54) Electronic mail certifying method and electronic mail certifying system using the same

(75) Inventors: Akimasa Ohta, Tokyo (JP); Hisaharu Sakamoto, Tokyo (JP)

Correspondence Address: SUGHRUE, MION, ZINN, MACPEAK & SEAS, 2100 Pennsylvania Avenue, N. W., Washington, DC, 20037-3202, US

(73) Assignee: NEC CORPORATION

(21) Appl. No.: 10/029,861

(22) Filed: Dec. 31, 2001

(30) Foreign Application Priority Data
Jan. 10, 2001 (JP) 2001-002001

(51) Int. Cl. G06F 15/16

(52) U.S. Cl. 709/206

(57) ABSTRACT

A sender information terminal 1 transmits a document mail needing a content certification to a sender information terminal 2, and transmits a copy of the document mail to a server 4 of a content certifying provider, and the sender information terminal 2, when receiving the document mail and confirming that it is the document mail needing the content certification, returns a reply mail to the sender information terminal 1, and transmits a copy of the reply mail to the server 4 of the content certifying provider, and the server 4 of the content certifying provider compares the copy of the document mail from the sender information terminal 1 with the copy of the reply mail from the receiver information terminal 2, and transmits the comparison result report to both the sender information terminal 1 and the receiver information terminal 2, and then performs a charging operation on the sender information terminal 1, in accordance with a charging information.

### BACKGROUND OF THE INVENTION

1. Field of the Invention

The present invention relates to an electronic mail certifying method and an electronic mail certifying system using the same. More particularly, the present invention relates to a method of certifying an electronic mail used in an on-line business and an on-line shopping.

2. Description of the Related Art

Conventionally, a transaction using an electronic mail has been carried out in an on-line business and an on-line shopping (a business and a purchase of goods using a network). Here, in a series of on-line transactions between a sender of the electronic mail and a receiver, there is not a disinterested organization to certify the sender and the receiver, respectively. For this reason, the justness with regard to the series of transactions between the sender and the receiver depends on the mutual reliability between the sender and the receiver. Or, even if there is the disinterested organization, it is necessary to record a predetermined information, a password and the like in advance in order to certify the justness.

Recently, the on-line business and the on-line shopping have been sharply increased by the spread of the Internet. In association with the sharp increase, a crime, such as a fraud, disguise as on other person and the like, has been increased in the on-line business and the online shopping.

In the above-mentioned conventional on-line business and on-line shopping, each of the sender of the electronic mail and the receiver can not be simply certified by the disinterested organization. Thus, it is impossible to easily certify the justness of the sender and the receiver in the series of transactions between the sender and the receiver. Hence, it is difficult to prevent the crime such as the fraud, the disguise and the like.

It is therefore an object of the present invention to provide an electronic mail certifying method, which can solve the above-mentioned problems and disinterestedly certify that there is no falsification in the transaction, the contract and the information transmission between both the sender and the receiver, and an electronic mail system using the same.

### SUMMARY OF THE INVENTION

An electronic mail certifying system according to the present invention includes: a server of a content certifying provider for carrying out a content certification of an electronic mail; a sender information terminal for transmitting a copy of the electronic mail to the server of the content certifying provider when the electronic mail needing the content certification is transmitted to a transmission destination; and a receiver information terminal, which when the electronic mail with the content certification is received from the sender information terminal, transmits a reply mail of the electronic mail to the sender information terminal, and transmits a copy of the reply mail to the server of the content certifying provider, wherein the server of the content certifying provider compares the copy of the electronic mail from the sender information terminal with the copy of the reply mail from the receiver information terminal, and then transmits the compared result to the sender information terminal and the receiver information terminal.

An electronic mail certifying method according to the present invention includes the steps of: transmitting a copy of an electronic mail from a sender information terminal to a server of a content certifying provider for carrying out a content certification of the electronic mail when the electronic mail needing the content certification is transmitted to a transmission destination; transmitting a reply mail of the electronic mail from a receiver information terminal to the sender information terminal after the electronic mail with the content certification is received from the sender information terminal, and transmitting a copy of the reply mail to the server of the content certifying provider; and comparing the copy of the electronic mail from the sender information terminal with the copy of the reply mail from the receiver information terminal, in the server of the content certifying provider and then transmitting the compared result to the sender information terminal and the receiver information terminal.

That is, the electronic mail certifying system of the present invention is characterized in that in order to certify the contents of the electronic mails respectively transmitted by the sender information terminal and the receiver information terminal in the usage of the on-line business and the on-line shopping, the copies of the electronic mails respectively transmitted by the sender information terminal and the receiver information terminal are transmitted to the content certifying provider in the position of the disinterested organization, and the content certifying provider compares the contents of the electronic mails with each other.

Actually, in the electronic mail certifying system according to the present invention, the sender information terminal transmits the document mail needing the content certification, such as the transmission destination of the mail, the date, the content and the like, to the sender information terminal and the server of the content certifying provider. The receiver information terminal transmits the reply mail to the sender information terminal and the server of the content certifying provider.

The server of the content certifying provider compares the contents of the electronic mails transmitted by the sender information terminal and the receiver information terminal with each other, and then transmits the compared result to the sender information terminal and the receiver information terminal.

As mentioned above, the sender information terminal and the receiver information terminal transmit the copies of the document mails to the server of the content certifying provider, and the server of the content certifying provider compares the contents of the document mails from both the sender information terminal and the receiver information terminal with each other Then, due to the agreement between the compared contents, it is possible to easily certify that there is not the falsification in the transaction, the contract and the information transmission between both the terminals, in the fair position of the disinterested organization.

### BRIEF DESCRIPTION OF THE DRAWINGS

FIG. 1 is a block diagram showing a configuration of an electronic mail certifying system according to an embodiment of the present invention;

FIG. 2 is a sequence chart showing an operation of an electronic mail certifying system according to an embodiment of the present invention; and

FIG. 3 is a block diagram showing an actual configuration of a server of the present invention.

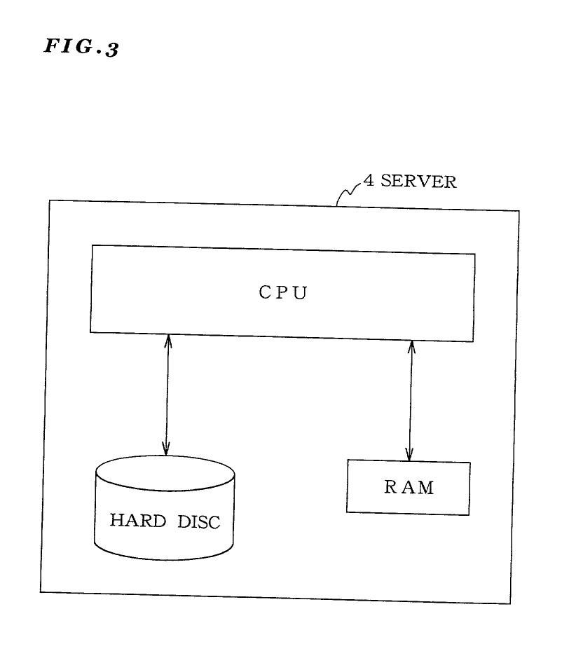

### DESCRIPTION OF THE PREFERRED EMBODIMENTS

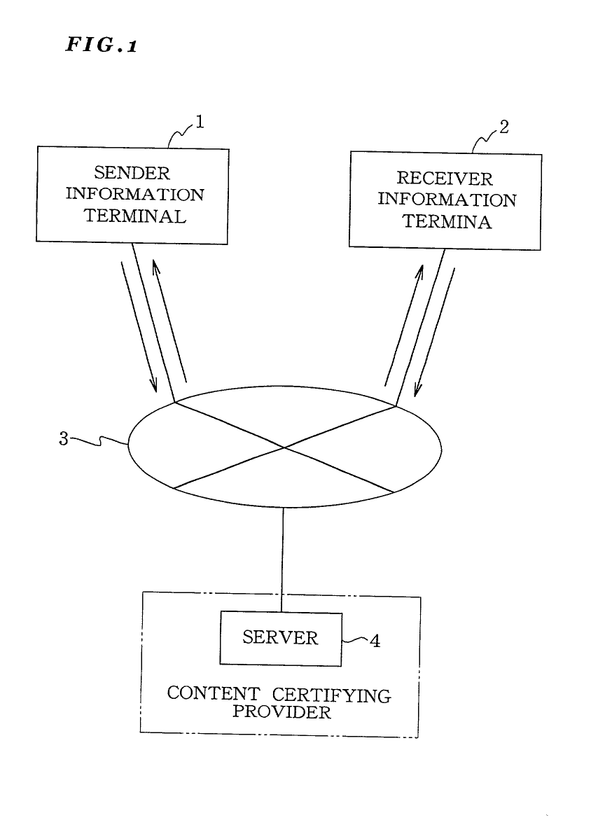

An embodiment of the present invention will be described below with reference to the drawings. FIG. 1 is a block diagram showing a configuration of an electronic mail certifying system according to the embodiment of the present invention. In FIG. 1, the electronic mail certifying system according to the embodiment of the present invention is constituted such that a sender information terminal 1, a receiver information terminal 2 and a server 4 of a content certifying provider are connected through a network 3 to each other. Then, an electronic mail is transmitted and received between the sender information terminal 1 and the receiver information terminal 2 on the network 3. The network in this case is, for example, the Internet.

The server 4 of the content certifying provider stores copies of the electronic mails transmitted by the sender information terminal 1 and the receiver information terminal 2, and keeps a charging information about the sender information terminal 1.

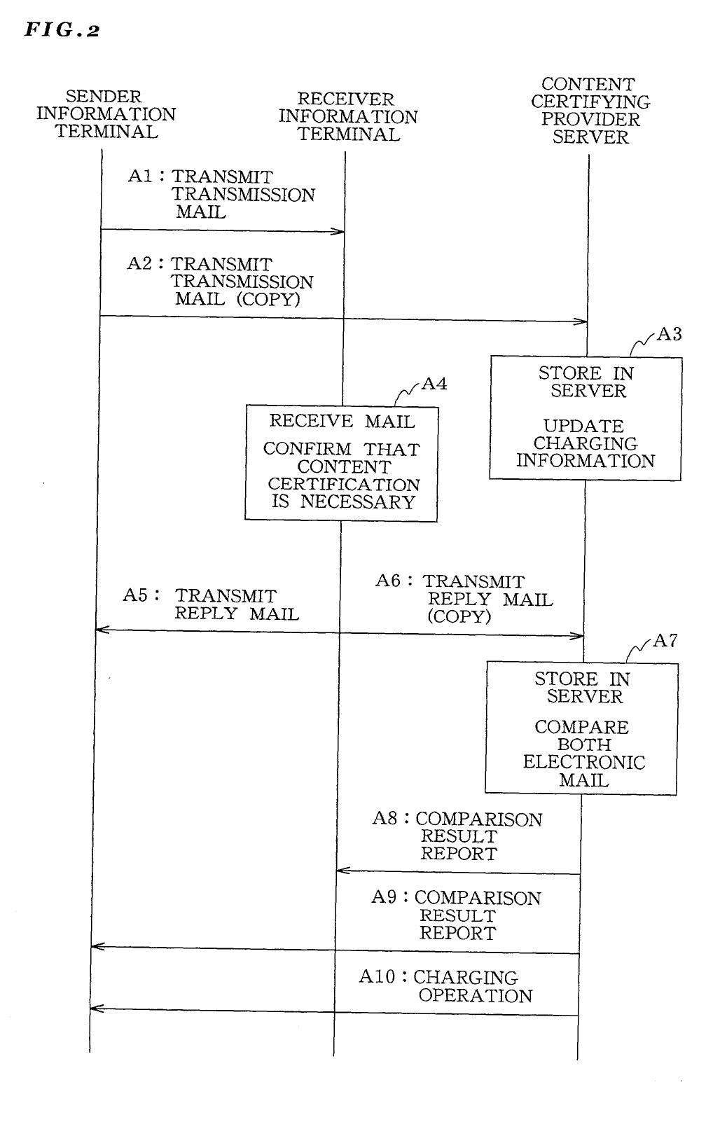

FIG. 2 is a sequence chart showing the operation of the electronic mail certifying system according to the embodiment of the present invention. The operation of the electronic mail certifying system according to the embodiment of the present invention will be described below with reference to FIG. 1 and FIG. 2. By the way, the electronic mail transmitted by the sender information terminal is referred to as a transmission mail, and the electronic mail transmitted by the receiver information terminal is referred to as a reply mail.

When the on-line business or the on-line shopping is used, the sender information terminal 1 transmits a transmission mail needing a content certification to the receiver information terminal 2 (A1 of FIG. 2), and transmits a copy of the transmission mail to the server 4 of the content certifying provider (A2 of FIG. 2).

The server 4 of the content certifying provider, when receiving the copy of the transmission mail transmitted by the sender information terminal 1, stores the copy of the transmission mail from the sender information terminal 1, and updates the charging information (A3 of FIG. 2).

On the other hand, the receiver information terminal 2, when receiving the transmission mail transmitted by the sender information terminal 1 and then confirming that it is the transmission mail needing the content certification (A4 of FIG. 2) , returns the reply mail to the sender information terminal 1 (A5 of FIG. 2) , and then transmits a copy of the reply mail to the server 4 of the content certifying provider (A6 of FIG. 2).

The server 4 of the content certifying provider, when receiving the copy of the reply mail transmitted by the receiver information terminal 2, stores the copy of the reply mail from the sender information terminal 2, and then compares a content of a copy of a transmission mail from the sender information terminal 1 with the copy of the reply mail from the receiver information terminal 2 (A7 of FIG. 7).

If as the compared result, there is not the falsification and the like in the content of the reply mail from the receiver information terminal 2, and both of them agree with each other to thereby indicate the justness, the server 4 of the content certifying provider transmits a comparison result report indicating that a series of electronic mail transmissions is valid, to both the sender information terminal 1 and the receiver information terminal 2 (A8, A9 of FIG. 2). Also, the server 4 of the content certifying provider carries out a charging operation to the sender information terminal 1 in accordance with the charging information (A10 of FIG. 2). Various methods are considered with regard to an actually charging operation. For example, an information with regard to a charged fee may be transmitted to the sender information terminal 1, and the sender may transfer the amount of money to a predetermined account. Or, it may be a payment by a credit card. By the way, the charging operation may be performed on the receiver information terminal 2 if the receiver information terminal 2 takes a some kind of merit.

Also, if as the compared result, there is the falsification and the like in the content of the reply mail transmitted by the receiver information terminal 2, and there is a disagreement between the transmission mail and the reply mail so that there is not the justness, the server 4 of the content certifying provider transmits a comparison result report indicating that the series of electronic mail transmissions is invalid and pointing out the item of the falsification content, to both the sender information terminal 1 and the receiver information terminal 2 (A8, A9 of FIG. 2).

As mentioned above, the sender information terminal 1 can instruct the server 4 of the content certifying provider to act as a checker for the presence or absence of the falsification, with regard to the reply mail transmitted by the receiver information terminal 2, in the usage of the on-line business or the on-line shopping.

Also, the receiver information terminal 2 can confirm that the series of electronic mail transmissions is valid, in the usage of the on-line business or the on-line shopping, by viewing the comparison result report transmitted by the server 4 of the content certifying provider.

By the way, the above-mentioned electronic mail certifying system can be attained, for example, by using a computer program stored in the server 4. That is, the server 4 includes a CPU for processing various information, a hard disc for storing the computer program, a RAM for temporally storing a predetermined information, and the like. Then, the CPU reads out a necessary computer program from the hard disc in advance. At this time, when the copy of the transmission mail is transmitted by the sender information terminal 1, the server 4 stores the copy of the transmission mail in the hard disc or the RAM, in accordance with the program, and it waits for the reception of the copy of the reply mail corresponding to the copy of the transmission mail. When receiving the copy of the reply mail, the server 4 compares the content of the copy of the transmission mail with the content of the copy of the reply mail. Then, the server 4 transmits the compared result to the sender information terminal 1 and the receiver information terminal 2. Of course, the server 4 has an interface to transmit and receive the electronic mail.

As mentioned above, according to the present invention, it has the following effect. That is, when the electronic mail needing the content certification is transmitted to the transmission destination, the copy of the transmission mail transmitted by the sender information terminal is transmitted to the server of the content certifying provider. When the electronic mail needing the content certification is received from the sender information terminal, the reply mail corresponding to the electronic mail is transmitted from the receiver information terminal to the sender information terminal, and the copy of the reply mail is transmitted to the server of the content certifying provider. The server of the content certifying provider compares the copy of the electronic mail from the sender information terminal with the copy of the reply mail from the receiver information terminal. The compared result is transmitted to the sender information terminal and the receiver information terminal. Thus, it is possible to easily certify that there is not the falsification in the transaction, the contract and the information transmission between both the terminals, in the fair position of the disinterested.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-002001 (Filed on Jan. 10, 2001) including specification, claims, drawings and summary are incorporated herein by reference in its entirety.

What is claimed is:

1. An electronic mail certifying system including:
a server of a content certifying provider for certifying a content of an electronic mail;
a sender information terminal which when a transmission mail needing the content certifying is transmitted to a transmission destination, transmits a copy of the transmission mail to the server of the content certifying provider; and
a receiver information terminal which when the transmission mail needing the content certifying is received from the sender information terminal, transmits a reply mail corresponding to the transmission mail to the sender information terminal, and transmits a copy of the reply mail to the server of the content certifying provider,
wherein the server of the content certifying provider compares the copy of the transmission mail from the sender information terminal with the copy of the reply mail from the receiver information terminal, and then transmits that compared result to the sender information terminal and the receiver information terminal.

2. An electronic mail certifying system according to claim 1, wherein the server of the content certifying provider performs a charging operation on at least one of the sender information terminal and the receiver information terminal at a time of a usage of the content certification.

3. An electronic mail certifying system according to claim 1, wherein the server of the content certifying provider stores the copy of the transmission mail from the sender information terminal and the copy of the reply mail from the receiver information terminal, respectively.

4. An electronic mail certifying system according to claim 1, wherein the server of the content certifying provider certifies at least transmission destinations, dates and contents of the electronic mails mutually transmitted from the sender information terminal and the receiver information terminal, in a usage of an on-line business or an on-line shopping.

5. An electronic mail certifying method comprising steps of:
sending a copy of a transmission mail needing a content certification from a sender information terminal to a server of a content certifying provider for carrying out a content certification of the transmission mail while sending the transmission mail from the sender information terminal to a transmission destination;
sending a copy of reply mail corresponding to the transmission mail from a receiver information terminal to the server of the content certifying provider while sending the reply mail to the sender information terminal;
comparing the copy of the transmission mail from the sender information terminal with the copy of the reply mail from the receiver information terminal by the server of the content certifying provider; and transmitting that compared result to the sender information terminal and the receiver information terminal.

6. An electronic mail certifying method according to claim 5, wherein the server of the content certifying provider performs a charging operation on at least one of the sender information terminal and the receiver information terminal at a time of a usage of the content certification.

7. An electronic mail certifying method according to claim 5, wherein the copy of the transmission mail from the sender information terminal and the copy of the reply mail from the receiver information terminal are respectively stored in the server of the content certifying provider.

8. An electronic mail certifying method according to claim 5, wherein the server of the content certifying provider certifies at least transmission -destinations, dates and contents of the electronic mails mutually transmitted from the sender information terminal and the receiver information terminal, in a usage of an on-line business or an on-line shopping.

9. A server of a content certifying provider for carrying out a content certification of an electronic mail, including the functions of:
receiving a copy of a transmission mail needing the content certification from a sender information terminal;
receiving a copy of the reply mail corresponding to the transmission mail from a receiver information terminal;
comparing the copy of the transmission mail from the sender information terminal with the copy of the reply mail from the sender information terminal; and transmitting that compared result to the sender information terminal and the receiver information terminal.

10. A computer program product stored in a computer readable storage medium for carrying out a content certification of an electronic mail, wherein this program is comprising processes of:
receiving a copy of a transmission mail needing the content certification from a sender information terminal;
receiving a copy of a reply mail corresponding to the transmission mail from a receiver information terminal;
comparing the copy of the transmission mail from the sender information terminal with the copy of the reply mail from the receiver information terminal; and transmitting that compared result to the sender information terminal and the receiver information terminal.
